(19) United States
(12) Patent Application Publication
(10) Pub. No.: US 2021/0195619 A1
(43) Pub. Date: Jun. 24, 2021

(54) OVER-THE-EDGE USER-SPECIFIC REFERENCE SYMBOLS

(71) Applicant: Nokia Technologies Oy, Espoo (FI)

(72) Inventors: Karol Schober, Helsinki (FI); Mihai Enescu, Espoo (FI)

(21) Appl. No.: 16/076,282

(22) PCT Filed: Feb. 9, 2016
(86) PCT No.: PCT/IB2016/050679

§ 371 Date: Aug. 7, 2018

(51) Int. Cl. H04W 72/12; H04L 5/00; H04W 72/04; H04W 72/08

(52) U.S. Cl. CPC H04W 72/1273; H04L 5/005; H04W 72/082; H04W 72/0473; H04L 5/0051

(57) ABSTRACT

A network node, such as an eNB, allocates a PRB allocation for transmission of at least one user-specific RS. The at least one user-specific RS is configured to be transmitted in a pattern. The at least one user-specific RS is transmitted to a UE. The pattern of the at least one user-specific RS includes at least one over-the-edge RS transmitted outside of the PRB allocation. A UE receives at least one user-specific RS in a pattern, and performs channel estimation based on the at least one user-specific RS. At least part of the at least one user-specific RS is in a PRB allocation of the UE and the pattern of the at least one user-specific RS includes at least one over-the-edge RS received outside of the PRB allocation of said UE.

### TECHNICAL FIELD

This invention relates generally to user-specific reference signals and, more specifically, relates to over-the-edge user-specific reference signals for channel estimation interpolation beyond an allocation edge.

### BACKGROUND

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section. Abbreviations that may be found in the specification and/or the drawing figures are defined below, after the main part of the detailed description section.

User-specific DM-RSs have been part of the LTE standard since Release 8, where one port demodulation/user-specific DM-RS were introduced in the transmission mode 7 of TDD. Subsequently, closed-loop MIMO transmission modes were introduced that employ DM-RS reference symbols supporting up to 8 ports. The main advantage of DM-RS is in their scalability with the number of layers transmitted to a user. In contrast, common RSs scale with the number of transmit antennas, which becomes impractical for a large transmit antenna arrays. Furthermore, user-specific DM-RSs allow implicit signaling of a spatial precoder.

Cell-specific RSs are available for all UEs communicating in a cell. The cell-specific RSs enable the UE to determine the phase reference for demodulating the downlink control channels and downlink data. Conventionally, cell-specific RSs are transmitted in all downlink subframes in a cell supporting non-multi-broadcast single-frequency transmission.

A UE may also receive user-specific DM-RSs that are embedded in the data transmitted for the specific UE. In this case, the UE receives user-specific DM-RSs in addition to cell-specific RSs. Conventionally, the user-specific DM-RSs are embedded only in the RBs to which the PDSCH is mapped for the UE. If user-specific DM-RSs are transmitted, the UE is expected to use these DM-RSs to derive the channel estimate for demodulating the data in the corresponding PDSCH RBs. A typical usage of the user-specific DM-RSs is to enable beamforming of the data transmissions to a specific UE. As an example, the user-specific DM-RSs may be used in precoding, where the user-specific DM-RSs are also precoded in the same manner as the data. Other use cases for DM-RS exist, for example, estimating the residual interference originating from other users scheduled on the same time and frequency resources in same or different cells.

In OFDMA, users are allocated a specific number of sub-carriers for a predetermined amount of time. These are referred to as physical resource blocks (PRBs) in the LTE specifications. PRBs have both a time and frequency dimension. The allocation of PRBs is handled by a scheduling function at the 3GPP base station (eNodeB).

Conventionally, user-specific DM-RSs are transmitted only within the allocated PRBs. This may be seen as a disadvantage as it prevents the UE's channel-estimator from interpolating on the edges of the allocated resource. The lack of interpolation at the edges becomes a limiting factor for the performance of frequency narrow allocations, such as 1-3 PRBs. The edge effect can be minimized (but not fully suppressed) by placing DM-RSs on the edge of the allocated PRBs. However, placing the DM-RSs on the edge increases the DM-RS overhead. Placing the DM-RSs on the edge of the PRB is also a disadvantage, for example, in the case of stacking more PRBs in frequency and/or time, where the DM-RSs located on the edge become somehow redundant.

PRB bundling in frequency for channel estimation is a solution adopted in the LTE specifications. The channel estimation is performed within 3 consecutive frequency PRBs and the overhead is 12 reference symbols per 1 PRB. Also for low cost machine-type communication (MTC) the channel estimation across multiple subframes in time is possible. While this may be currently sufficient, latency requirements of LTE Pro/5G shorten the TTI, and cannot afford the overhead of 12 reference symbols in 1 PRB. Therefore, the LTE Pro/5G latency requirements may rely on channel interpolation gain suppressing the noise.

### BRIEF SUMMARY

This section is intended to include examples and is not intended to be limiting.

In accordance with an exemplary method, a network node, such as an eNB, allocates a PRB allocation for transmission of at least one user-specific RS. The at least one user-specific RS is configured to be transmitted in a pattern. The at least one user-specific RS is transmitted to a UE. The pattern of the at least one user-specific RS includes at least one over-the-edge RS transmitted outside of the PRB allocation.

The pattern of the at least one user-specific RS may be beyond an edge of the PRB allocated to the UE. Another PRB beyond the edge of the PRB allocation may be allocated to another UE. A physical downlink shared channel of said another UE may be rate matched around the pattern of the at least one user-specific RS. The pattern of the at least one user-specific RS includes at least one in-band RS that is within the PRB allocation and at least one over-the-edge RS that is outside of the PRB allocation. Two or more of the at least one over-the-edge RS may be uniformly spaced with respect to the at least one in-band RS located within the allocated PRB. A RS at the edge of the allocation may be multiplexed if same resource elements are used for the PRB allocation and a PRB allocation of a neighboring UE. The multiplexed RS at the edge of the allocation may result in power boosted of the multiplexed RS. The pattern of the at least one user-specific RS may include over-the-edge RSs transmitted outside of the PRB allocation. The at least one RS transmitted outside of the PRB may be allocated so it does not overlap with another PRB allocated to another UE. The pattern of the at least one user-specific RS of the UE may be configured to overlay another pattern of user-specific RSs of the UE.

In accordance with another exemplary embodiment, an apparatus comprises at least one processor and at least one memory including computer program code. The at least one memory and the computer program code are configured to, with the at least one processor, cause the apparatus to perform at least the following: allocate, by a network node, a PRB for transmission of at least one user-specific RS, configure the at least one user-specific RS to be transmitted in a pattern, and transmit to a UE the pattern of the at least one user-specific RS. The pattern of the at least one user-specific RS includes over-the-edge RSs transmitted outside of the PRB allocation.

In accordance with another exemplary embodiment, a computer program product comprises a computer-readable medium bearing computer program code embodied therein for use with a computer. The computer program code comprises: code for allocating, by a network node, a PRB for transmission of at least one user-specific RS, code for configuring the at least one user-specific RS to be transmitted in a pattern, and code for transmitting to a UE the pattern of the at least one user-specific RS. The pattern of the at least one user-specific RS includes over-the-edge RSs transmitted outside of the PRB allocation.

In accordance with another exemplary embodiment, an apparatus comprises means for allocating, by a network node, a PRB for transmission of at least one user-specific RS, means for configuring the at least one user-specific RS to be transmitted in a pattern, and means for transmitting to a UE the pattern of the at least one user-specific RS. The pattern of the at least one user-specific RS includes over-the-edge RSs transmitted outside of the PRB allocation.

In accordance with another exemplary embodiment, a method comprises receiving, by a UE, a PRB allocation from a network node for transmission of at least one user-specific RS, wherein the at least one user-specific RSs are configured to be transmitted in a pattern, and receiving, by the UE, the pattern of the at least one user-specific RS. The pattern of the at least one user-specific RS includes over-the-edge RSs transmitted outside of the PRB allocation.

In accordance with another exemplary embodiment, an apparatus comprises at least one processor and at least one memory including computer program code. The at least one memory and the computer program code are configured to, with the at least one processor, cause the apparatus to perform at least the following: receive, by a UE, a PRB allocation from a network node for transmission of at least one user-specific RS, wherein the at least one user-specific RSs are configured to be transmitted in a pattern, and receive, by the UE, the pattern of the at least one user-specific RS. The pattern of the at least one user-specific RS includes over-the-edge RSs transmitted outside of the PRB allocation.

In accordance with another exemplary embodiment, a computer program product comprises a computer-readable medium bearing computer program code embodied therein for use with a computer. The computer program code comprises: code for receiving, by a UE, a PRB allocation from a network node for transmission of at least one user-specific RS, wherein the at least one user-specific RSs are configured to be transmitted in a pattern, and code for receiving, by the UE, the pattern of the at least one user-specific RS. The pattern of the at least one user-specific RS includes over-the-edge RSs transmitted outside of the PRB allocation.

In accordance with another exemplary embodiment, an apparatus, comprises means for receiving, by a UE, a PRB allocation from a network node for transmission of at least one user-specific RS, wherein the at least one user-specific RSs are configured to be transmitted in a pattern, and means for receiving, by the UE, the pattern of the at least one user-specific RS. The pattern of the at least one user-specific RS includes over-the-edge RSs transmitted outside of the PRB allocation.

### BRIEF DESCRIPTION OF THE DRAWINGS

In the attached Drawing Figures:

FIG. 1 is a block diagram of one possible and non-limiting exemplary system in which the exemplary embodiments may be practiced;

FIG. 2A is a logic flow diagram for allocating and transmitting over-the-edge user-specific reference symbols, and illustrates the operation of an exemplary method, a result of execution of computer program instructions embodied on a computer readable memory, functions performed by logic implemented in hardware, and/or interconnected means for performing functions in accordance with exemplary embodiments;

FIG. 2B is a logic flow diagram for grouping and transmitting a pattern of reference symbol resources grouped for improved channel estimation, and illustrates the operation of an exemplary method, a result of execution of computer program instructions embodied on a computer readable memory, functions performed by logic implemented in hardware, and/or interconnected means for performing functions in accordance with exemplary embodiments;

FIG. 3 illustrates DM-RS ports configured on a legacy LTE TTI in accordance with an exemplary embodiment;

FIG. 4 illustrates two flipped patterns of REs allocated to two UEs;

FIG. 5 illustrates a staggered and rotated pattern of REs with three sub-carrier DM-RS spacing; and

FIG. 6 illustrates a case where two users UE1 and UE2 with 2-symbol sTTI are multiplexed in time.

### DETAILED DESCRIPTION OF THE DRAWINGS

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The exemplary embodiments herein describe techniques for user RSs for wireless communications. Additional description of these techniques is presented after a system into which the exemplary embodiments may be used is described.

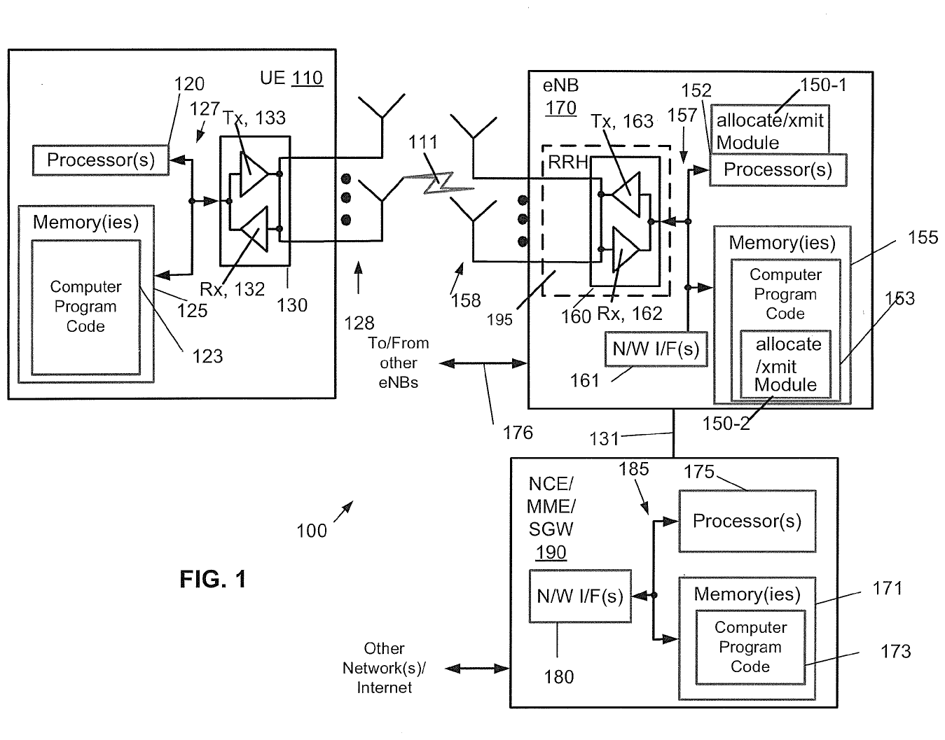

Turning to FIG. 1, this figure shows a block diagram of one possible and non-limiting exemplary system in which the exemplary embodiments may be practiced. In FIG. 1, a UE (UE) 110 is in wireless communication with a wireless network 100. A UE is a wireless, typically mobile device that can access a wireless network. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123.

The eNB (evolved NodeB) 170 is a base station (e.g., for LTE, long term evolution) that provides access by wireless devices such as the UE 110 to the wireless network 100. The eNB 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The eNB 170 includes a user-specific DM-RSs allocating and transmitting module 150, comprising one of or both parts 150-1 and/or 150-2, which may be implemented in a number of ways. The user-specific DM-RSs allocating and transmitting module 150 may be implemented in hardware as user-specific DM-RSs allocating and transmitting module 150-1, such as being implemented as part of the one or more processors 152. The user-specific DM-RSs allocating and transmitting module 150-1 may be implemented also as an integrated circuit or through other hardware such as a programmable gate array. In another example, the user-specific DM-RSs allocating and transmitting module 150 may be implemented as user-specific DM-RSs allocating and transmitting module 150-2, which is implemented as computer program code 153 and is executed by the one or more processors 152. For instance, the one or more memories 155 and the computer program code 153 are configured to, with the one or more processors 152, cause the eNB 170 to perform one or more of the operations as described herein. The one or more network interfaces 161 communicate over a network such as via the links 176 and 131. Two or more eNBs 170 communicate using, e.g., link 176. The link 176 may be wired or wireless or both and may implement, e.g., an X2 interface.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195, with the other elements of the eNB 170 being physically in a different location from the RRH, and the one or more buses 157 could be implemented in part as fiber optic cable to connect the other elements of the eNB 170 to the RRH 195.

The wireless network 100 may include a network control element (NCE) 190 that may include MME (Mobility Management Entity)/SGW (Serving Gateway) functionality, and which provides connectivity with a further network, such as a telephone network and/or a data communications network (e.g., the Internet). The eNB 170 is coupled via a link 131 to the NCE 190. The link 131 may be implemented as, e.g., an S1 interface. The NCE 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the NCE 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, eNB 170, and other functions as described herein.

In general, the various embodiments of the UE 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

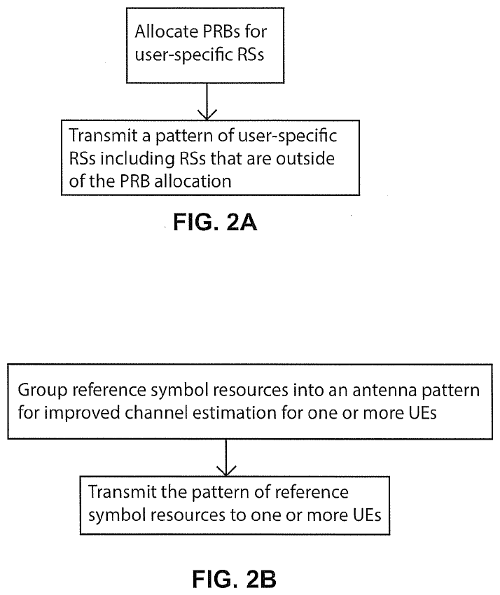

FIG. 2A is a logic flow diagram for allocating and transmitting over-the-edge user-specific reference symbols. The eNB, for example, allocates PRBs for user-specific DM-RSs. The eNB then transmits a pattern of user-specific DM-RSs including DM-RSs that are outside the PRBs allocation. This figure further illustrates the operation of an exemplary method, a result of execution of computer program instructions embodied on a computer readable memory, functions performed by logic implemented in hardware, and/or interconnected means for performing functions in accordance with exemplary embodiments. The blocks in FIG. 2A are assumed to be performed by a base station such as eNB 170, e.g., under control of the user-specific DM-RSs allocating and transmitting module 150 at least in part.

FIG. 2B is a logic flow diagram for grouping and transmitting a pattern of reference symbol resources grouped for improved channel estimation. An eNB, for example, groups reference symbol resources into a pattern grouped for improved channel estimation for one or more UEs. The eNB then transmits the pattern of reference symbol resources to the one or more UEs. This figure further illustrates the operation of an exemplary method, a result of execution of computer program instructions embodied on a computer readable memory, functions performed by logic implemented in hardware, and/or interconnected means for performing functions in accordance with exemplary embodiments. The blocks in FIG. 2B are assumed to be performed by a base station such as eNB 170, e.g., under control of the user-specific DM-RSs allocating and transmitting module 150 at least in part.

In accordance with an exemplary embodiment, user-specific reference symbols of a UE are present within the data allocation for the UE as well as outside this data allocation, allowing channel estimation interpolation beyond the edge of the data allocation.

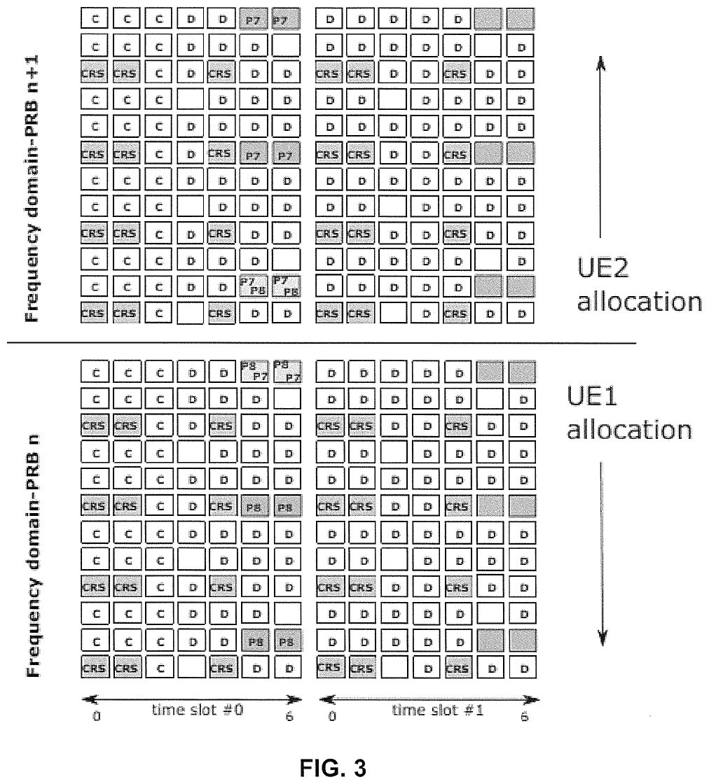

FIG. 3 illustrates how DM-RS ports can be configured on legacy LTE TTI according to an exemplary embodiment. The figure shows two PRB-pairs and the allocation edge between UE1 and UE2. Both users are served only in slot 0 being a shorter TTI. The sub-carriers marked P7/P8 include both port 7 and port 8, allowing for over the edge interpolation. Furthermore, the sub-carriers marked P7/P8 may be allocated with double power, to maintain PDSCH to DM-RS EPRE.

It is noted that the legacy LTE DM-RS design may not be the best approach for the operation of an exemplary embodiment. For example, in the LTE system, the DM-RS may be designed such that over-the-edge reference symbols are uniformly spaced with respect to in-band DM-RS. In this case, neighbouring UEs could utilize rate-matching around neighbour's DM-RS by default, could be signalled about the presence of a neighbour's DM-RS, and could blind detect the presence of a neighbour's DM-RS. At least in accordance with this usage, the contamination of un-allocated resources may only happen at the edge of the allocated band, for example, when UE1 is allocated but UE2 is not.

When UE1 is aware of the UE2's over-the-edge RS, the eNB does not place UE1's PDSCH data symbols on those resource elements. This mechanism of skipping over the resource elements is called rate-matching in 3GPP LTE, because leaving out or not transmitting some redundancy bits results in a change of the coding rate. UE1 can be signalled about the presence of a neighbour's DM-RSs dynamically or semi-statically. To avoid signalling overhead, UE1 may perform blind detection of DM-RSs in a neighbouring allocated resource. Presence of DM-RSs may imply presence of the over-the-edge DM-RSs. In the case of even shorter TTIs, such as 2 OFDM-symbols TTI, an over-the edge DM-RSs according to an exemplary embodiment would puncture the data of legacy UEs. Data puncturing means that eNB replaces data resource element (RE) with RS, however, a legacy UE expects a valid data symbol at that RE. This causes trouble to the legacy UE. However, the legacy UEs can tolerate a small amount of puncturing, similar to the manner in which CSI-RS of Release 9 are tolerated by Release 8 UEs where there are two CSI-RS REs per PRB per port. In some OFDM-symbols, the eNB could configure these CSI-RS on the REs colliding with over-the edge DM-RS. Such that, an eNB could rate match data for the victim UE (Release 9). The impact on a legacy UE would thus be minimized.

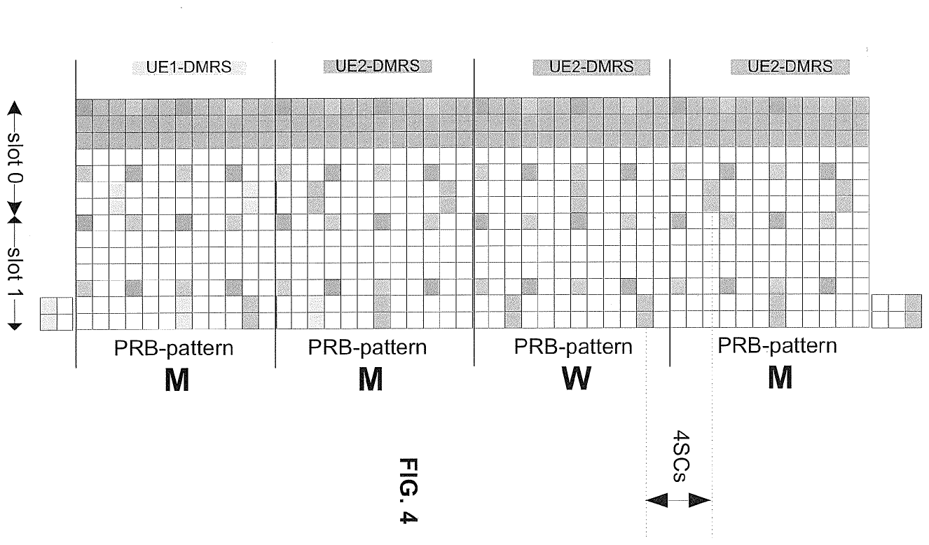

In accordance with another exemplary embodiment, a new pattern of reference symbol resources is possible as shown in FIG. 4. In accordance with this embodiment, an antenna pattern improves channel estimation performance at the edge of an allocated user's band with two patterns, W and M, provided. The W and M patterns consist of the same amount of reference symbol resources with equal sub-carrier (SC) spacing such as 4 sub-carrier spacing in this case, but the reference symbol resources are grouped in flipped patterns (hence the choice of letters W and M).

As shown in FIG. 4, when the pattern has 6 RSs in slot 1 and 4 RSs in slot 0, the pattern reassembles M. When the pattern has 6 RSs in slot 0 and 4 RSs in slot 1, the pattern reassembles W. When two UEs are concatenated in frequency, only M-M and W-W are usable at the boarders. Allocating M-W at the boarders would result in collision between RS of neighbouring UEs. However, in order to save DM-RS overhead for users with continuous allocation, the eNB communicating with the UEs may allocate patterns like WMW or MWM to users, with only 8 REs per PRB in case of infinite allocation.

In contrast, when the same patterns are concatenated, i.e. WWW or MMM, the overhead is 10 REs per PRB. FIG. 4 shows the configuration M-MWM allocated to two users, UE1 and UE2. If the allocation of the UE is at the edge of the system bandwidth, naturally there are no out-of-band DM-RSs. In accordance with an exemplary embodiment, the UE specific flipping and mirroring of the reference symbol resources pattern provides improved channel estimation at the PRB allocation edge with no redundant DM-RS overhead in the case of PRB bundling in frequency. Similarly, over the edge resource elements can be present in time.

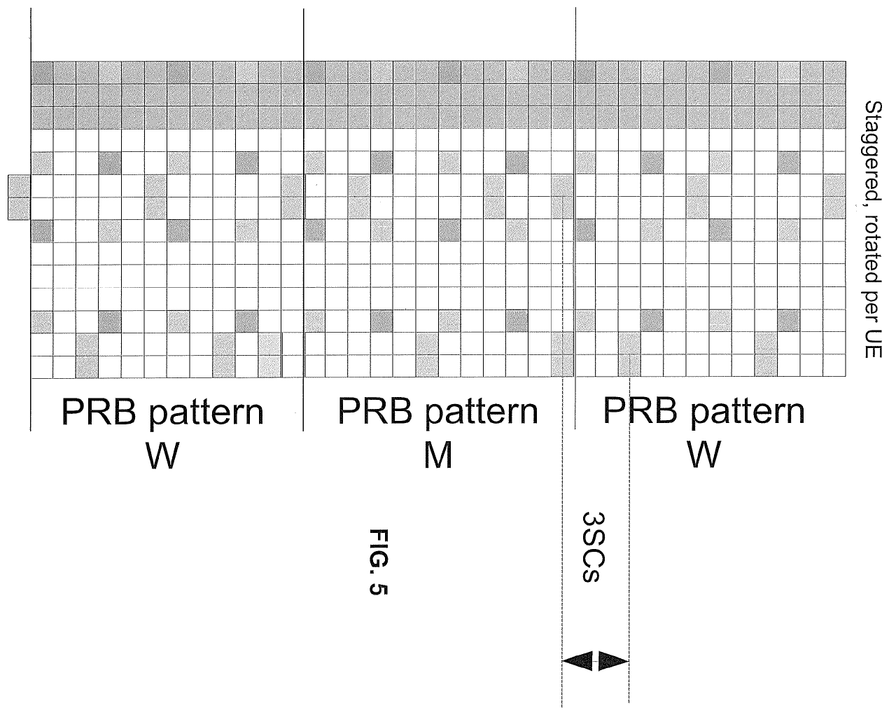

FIG. 5 illustrates a staggered and rotated pattern WMW of REs with three SC DM-RS spacing. By grouping the DM-RS into, for example, the W and M patterns shown in FIGS. 4 and 5, the DM-RS overhead is increased only at the edge. With pattern design in FIG. 4, the same patterns, for example W-W or M-M, are required at the PRB allocation edge, and patterns alternate within the same allocation in order to decrease overhead. Contrary, with pattern design in FIG. 5, different patterns, for example W-M or M-W, are required at the allocation edge, and the same pattern needs to be used within one allocation, in order to decrease overhead. In FIG. 5, if the W is for UE1 and UE3, then the M is for UE2, which forms the WMW pattern. And, if the M is for UE1 and UE3, then the W is for UE2, which forms the MWM pattern. In both cases, overhead at allocation edges increases. At the edge between two allocations, the PRB RS patterns do not overlap, while within the allocation, the PRB RS patterns do overlap to achieve decreased overhead. The patterns are defined per PRB. For example, two patterns may be defined per PRB, W and M which alternate, where the “dash” in W-MW denotes the PRB allocation edge. The patterns are grouped in a specific way to achieve a decrease in the overhead inside of the allocation, and enabling channel estimation at the edge

Conventionally, user-specific DM-RSs are transmitted only within the allocated resource, which prevents the UE's channel estimator from being able to interpolate on the edges of the allocated band. The edge effect can be minimized, although may not be fully suppressed, by placing RSs on the edge. In accordance with an exemplary embodiment, as described herein and shown in the figures, user-specific reference symbols are configured to be present outside of the data allocation, allowing channel estimation interpolation to be enabled beyond the edge of UE's allocation.

In accordance with an exemplary embodiment, UE specific flipping and mirroring of the PRB pattern, for example, includes a MWM pattern shown in the figures is provided for the same UE, or, alternatively, a staggering WMW pattern may be used with different UEs neighbouring allocation rate-match around the over-the-edge DM-RS. For example, this would be the case of LTE or 5G implementation, where there is still flexibility in the creation of standard. In LTE implementations which need to take into account legacy UEs (from previous releases), over-the-edge DM-RS resources could collide in position with a DM-RS port of a neighbouring allocation, and could use CDM to maintain orthogonality. For example, in this case, UE1 employs port 7 and UE2 port 8, which are orthogonal in the code domain. Furthermore, the eNB can puncture over the edge positions. That is, a legacy UE may operate as if there is a PDSCH symbol, but instead there is DM-RS. The impact of puncturing is small, because, for example, error-correcting convolutional turbo code can correct it. The effect of puncturing has been studied in 3GPP, when CSI-RS have been introduced in Release 9. It has been observed that puncturing of a small amount of REs, for example between 2 and 4 per PRB, is tolerable. Alternatively, an eNB can use a CSI-RS configuration to “mask” the over-the-edge DM-RS. In this case eNB performs rate-matching instead of puncturing, which has smaller effect on legacy UEs.

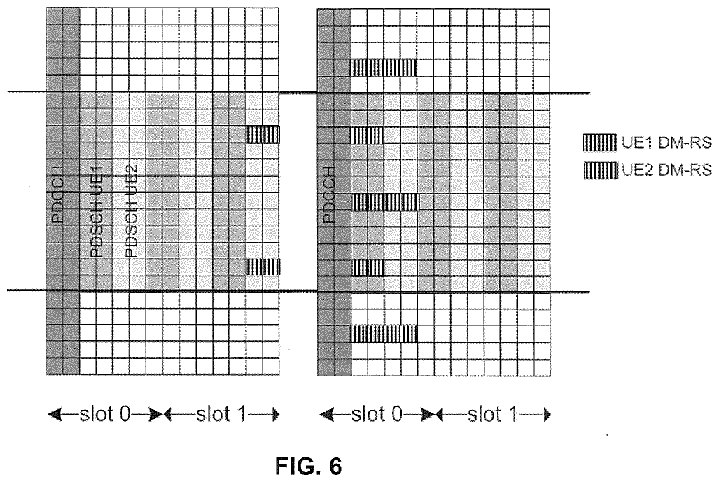

FIG. 6 illustrates a case where two users UE1 and UE2 with 2-symbol sTTI are multiplexed in time. In order to support DM-RS for higher speeds, the over-the-edge DM-RS spread to previous sTTI, which belongs to other UE.

In accordance with an exemplary embodiment, an apparatus comprises means for allocating, by a network node, a PRB for transmission of at least one user-specific RS; means for configuring the at least one user-specific RS to be transmitted in a pattern; and means for transmitting to a UE the pattern of the at least one user-specific RS.

The pattern of the at least one user-specific RS may include over-the-edge RSs transmitted outside of the PRB allocation for channel estimation interpolation beyond an edge of the PRB allocated to the UE. Another PRB beyond the edge of the PRB allocated to the UE may be allocated to another UE. The pattern of the at least one user-specific RS may include at least one in-band RS that is within the PRB allocation and at least one over-the-edge RS that is outside of the PRB allocation. Two or more of the at least one over-the-edge RS may be uniformly spaced with respect to the at least one in-band RS located within the allocated PRB. The spaces between the over-the-edge RSs are equal with respect to the in-band RS. The pattern of user-specific RSs may include over-the-edge RSs transmitted outside of the PRB allocation, where said at least one RS transmitted outside of the PRB does not overlap with another PRB allocated to another UE.

In accordance with an exemplary embodiment, an apparatus comprises means for receiving, by a UE, a PRB allocation from a network node for transmission of at least one user-specific RS, wherein the at least one user-specific RSs are configured to be transmitted in a pattern; and means for receiving, by the UE, the pattern of the at least one user-specific RS.

As with other embodiments described herein, the pattern of the at least one user-specific RS may include over-the-edge RSs transmitted outside of the PRB allocation for channel estimation interpolation beyond an edge of the PRB allocated to the UE. Another PRB beyond the edge of the PRB allocated to the UE may be allocated to another UE. The pattern of the at least one user-specific RS may include at least one in-band RS that is within the PRB allocation and at least one over-the-edge RS that is outside of the PRB allocation. Two or more of the at least one over-the-edge RS may be uniformly spaced with respect to the at least one in-band RS located within the allocated PRB. The pattern of user-specific RSs may include over-the-edge RSs transmitted outside of the PRB allocation, where said at least one RS transmitted outside of the PRB does not overlap with another PRB allocated to another UE.

In accordance with exemplary embodiments, the pattern of the at least one user-specific RS may be beyond an edge of the PRB allocated to the UE. Another PRB beyond the edge of the PRB allocation may be allocated to another UE. A physical downlink shared channel of said another UE may be rate matched around the pattern of the at least one user-specific RS. The pattern of the at least one user-specific RS includes at least one in-band RS that is within the PRB allocation and at least one over-the-edge RS that is outside of the PRB allocation. Two or more of the at least one over-the-edge RS maybe uniformly spaced with respect to the at least one in-band RS located within the allocated PRB. A RS at the edge of the allocation may be multiplexed if same resource elements are used for the PRB allocation and a PRB allocation of a neighboring user equipment. The multiplexed RS at the edge of the allocation may result in power boosted of the multiplexed RS. The pattern of the at least one user-specific RS may include over-the-edge RSs transmitted outside of the PRB allocation. The at least one RS transmitted outside of the PRB may be allocated so it does not overlap with another PRB allocated to another UE. The pattern of the at least one user-specific RS of the UE may be configured to overlay another pattern of user-specific RSs of the UE.

Without in any way limiting the scope, interpretation, or application of the claims appearing below, a technical effect of one or more of the example embodiments disclosed herein is user-specific reference symbols of a UE are present within the data allocation for the UE as well as outside this data allocation, allowing channel estimation interpolation beyond the edge of the data allocation. Another technical effect of one or more of the example embodiments disclosed herein is an antenna pattern having reference symbol resources grouped in flipped patterns to improve channel estimation performance at the edge of an allocated user's band.

The following are possible examples.

Example 1. A method, comprising: allocating, by a network node, a physical resource block allocation for transmission of at least one user-specific reference signal; and transmitting to a user equipment the at least one user-specific reference signal in a pattern, wherein the pattern of the at least one user-specific reference signal includes at least one over-the-edge reference signal transmitted outside of the physical resource block allocation.

Example 2. The method of example 1, wherein the pattern of the at least one user-specific reference signal enables channel estimation beyond an edge of the physical resource block allocated to the user equipment.

Example 3. The method of example 1 or example 2, wherein another physical resource block allocation beyond the edge of the physical resource block allocation is allocated to another user equipment.

Example 4. The method of example 3, wherein a physical downlink shared channel of said another user equipment is rate matched around the pattern of the at least one user-specific reference signal.

Example 5. The method of any one of examples 1 through 4, wherein the pattern of the at least one user-specific reference signal includes at least one in-band reference signal that is within the physical resource block allocation and at least one over-the-edge reference signal that is outside of the physical resource block allocation.

Example 6. The method of example 5, wherein two or more of the at least one over-the-edge reference signal are uniformly spaced with respect to the at least one in-band reference signal located within the physical resource block allocation.

Example 7. The method of example 1, wherein a reference signal at an edge of the physical resource block allocation is multiplexed if same resource elements are used for the physical resource block allocation and a physical resource block allocation of a neighboring user equipment.

Example 8. The method of example 7, wherein the multiplexed reference signal at the edge of the physical resource block allocation results in boosted power of the multiplexed reference signal.

Example 9. The method of any one of examples 1 through 8, where said at least one over-the-edge reference signal transmitted outside of the physical resource block does not overlap with another physical resource block allocated to another user equipment.

Example 10. The method of any one of examples 1 through 9, wherein the pattern of the at least one user-specific reference signal of the user equipment overlays another pattern of user-specific reference signals of the user equipment.

Example 11. An apparatus, comprising: at least one processor; and at least one memory including computer program code, the at least one memory and the computer program code configured to, with the at least one processor, cause the apparatus to perform at least the following: allocate a physical resource block for transmission of at least one user-specific reference signal; and transmit to a user equipment the at least one user-specific reference signal in a pattern, wherein the pattern of the at least one user-specific reference signal includes at least one over-the-edge reference signal transmitted outside of the physical resource block allocation.

Example 12. The apparatus of example 11, wherein the pattern of the at least one user-specific reference signal enables channel estimation beyond an edge of the physical resource block allocated to the user equipment.

Example 13. The apparatus of example 11 or example 12, wherein another physical resource block beyond the edge of the physical resource block allocation is allocated to another user equipment.

Example 14. The apparatus of example 13, wherein a physical downlink shared channel of said another user equipment is rate matched around the pattern of the at least one user-specific reference signal.

Example 15. The apparatus of any one of examples 11 through 14, wherein the pattern of the at least one user-specific reference signal includes at least one in-band reference signal that is within the physical resource block allocation and at least one over-the-edge reference signal that is outside of the physical resource block allocation.

Example 16. The apparatus of example 15, wherein two or more of the at least one over-the-edge reference signal are uniformly spaced with respect to the at least one in-band reference signal located within the physical resource block allocation.

Example 17. The apparatus of example 11, wherein a reference signal at an edge of the physical resource block allocation is multiplexed if same resource elements are used for the physical resource block allocation and a physical resource block allocation of a neighboring user equipment.

Example 18. The apparatus of example 17, wherein the multiplexed reference signal at the edge of the physical resource block allocation results in boosted power of the multiplexed reference signal.

Example 19. The apparatus of any one of examples 11 through 18, wherein said at least one over-the-edge reference signal transmitted outside of the physical resource block does not overlap with another physical resource block allocated to another user equipment.

Example 20. The apparatus of any one of examples 11 through 19, wherein the pattern of the at least one user-specific reference signal of the user equipment overlays another pattern of user-specific reference signals of the user equipment.

Example 21. An apparatus, comprising: means for allocating a physical resource block for transmission of at least one user-specific reference signal; and means for transmitting to a user equipment the at least one user-specific reference signal in a pattern, wherein the pattern of the at least one user-specific reference signal includes at least one over-the-edge reference signal transmitted outside of the physical resource block allocation.

Example 22. The apparatus of example 22, comprising means for performing the methods of any one of the examples 2 to 10.

Example 23. A method, comprising: receiving, by a user equipment, at least one user-specific reference signal in a pattern, and performing channel estimation based on the at least one user-specific reference signal, wherein at least part of the at least one user-specific reference signal is in a physical resource block allocation of the user equipment and the pattern of the at least one user-specific reference signal includes at least one over-the-edge reference signal received outside of the physical resource block allocation of said user equipment.

Example 24. The method of example 23, wherein the pattern of the at least one user-specific reference signal enables channel estimation beyond an edge of the physical resource block allocated to the user equipment.

Example 25. The method of example 23 or example 24, wherein another physical resource block allocation beyond an edge of the physical resource block allocation is for another user equipment.

Example 26. The method of example 25, wherein a physical downlink shared channel of said another user equipment is rate matched around the pattern of the at least one user-specific reference signal.

Example 27. The method of any one of example 23 through 26, wherein the pattern of the at least one user-specific reference signal includes at least one in-band reference signal that is within the physical resource block allocation and at least one over-the-edge reference signal that is outside of the physical resource block allocation.

Example 28. The method of example 27, wherein two or more of the at least one over-the-edge reference signal are uniformly spaced with respect to the at least one in-band reference signal located within the physical resource block allocation.

Example 29. The method of example 23, wherein a reference signal at an edge of the physical resource block allocation is multiplexed if same resource elements are used for the physical resource block allocation and a physical resource block allocation of a neighboring user equipment.

Example 30. The method of example 29, wherein the multiplexed reference signal at the edge of the physical resource block allocation results in boosted power of the multiplexed reference signal.

Example 31. The method of any one of examples 23 through 30, wherein said at least one reference signal received outside of the physical resource block allocation does not overlap with another physical resource block of another user equipment.

Example 32. The method of any one of examples 27 through 31, wherein the pattern of the at least one user-specific reference signal of the user equipment overlays another pattern of user-specific reference signals of the user equipment.

Example 33. An apparatus, comprising: at least one processor; and at least one memory including computer program code, the at least one memory and the computer program code configured to, with the at least one processor, cause the apparatus to perform at least the following: receive at least one user-specific reference signal in a pattern; and perform channel estimation based on the at least one user-specific reference signal, wherein at least part of the at least one user-specific reference signal is in a physical resource block allocation of the a user equipment and the pattern of the at least one user-specific reference signal includes at least one over-the-edge reference signal received outside of the physical resource block allocation of the user equipment.

Example 34. The apparatus of example 33, wherein the pattern of the at least one user-specific reference signal enables channel estimation beyond an edge of the physical resource block allocated to the user equipment.

Example 35. The apparatus of example 33 or example 34, wherein another physical resource block allocation beyond the edge of the physical resource block allocation of the user equipment is for another user equipment.

Example 36. The apparatus of example 35, wherein a physical downlink shared channel of said another user equipment is rate matched around the pattern of the at least one user-specific reference signal.

Example 37. The apparatus of any one of examples 33 through 36, wherein the pattern of the at least one user-specific reference signal includes at least one in-band reference signal that is within the physical resource block allocation and at least one over-the-edge reference signal that is outside of the physical resource block allocation.

Example 38. The apparatus of example 37, wherein two or more of the at least one over-the-edge reference signal are uniformly spaced with respect to the at least one in-band reference signal located within the physical resource block allocation.

Example 39. The apparatus of example 33, wherein a reference signal at an edge of the physical resource block allocation is multiplexed if same resource elements are used for the physical resource block allocation and a physical resource block allocation of a neighboring user equipment.

Example 40. The apparatus of example 39, wherein the multiplexed reference signal at the edge of the physical resource block allocation results in boosted power of the multiplexed reference signal.

Example 41. The apparatus of any one of examples 33 through 40, wherein said at least one over-the-edge reference signal received outside of the physical resource block does not overlap with another physical resource block for another user equipment.

Example 42. The apparatus of any one of examples 37 through 41, wherein the pattern of the at least one user-specific reference signal of the user equipment overlays another pattern of user-specific reference signals of the user equipment.

Example 43. An apparatus, comprising: means for receiving at least one user-specific reference signal in a pattern; and means for performing channel estimation based on the at least one user-specific reference signal, wherein at least part of the at least one user-specific reference signal is in a physical resource block allocation of the user equipment and the pattern of the at least one user-specific reference signal includes at least one over-the-edge reference signals received outside of the physical resource block allocation.

Example 44. The apparatus of example 43, comprising means for performing the methods of any one of the examples 24 to 32.

Example 45. A computer program comprising program code for executing the method according to any of examples 1 to 10 or 23 to 32.

Example 46. The computer program according to example 45, wherein the computer program is a computer program product comprising a computer-readable medium bearing computer program code embodied therein for use with a computer.

Example 47. A system comprising any one of the apparatus of claim 21 or 22 and any one of the apparatus of claim 43 or 44.

Example 48. A system comprising any one of the apparatus of claims 11 to 20 and any one of the apparatus of claims 33 to 42.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memories 125, 155, 171 or other device) that may be any media or means that can contain, store, and/or transport the instructions for use by or in connection with an instruction execution system, apparatus, or device, such as a computer. A computer-readable storage medium does not comprise propagating signals.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:
DM-RS demodulation reference signals
eNB (or eNodeB) evolved Node B (e.g., an LTE base station)
EPRE energy per resource element
I/F interface
LTE long term evolution
MIMO multiple in, multiple out
MME mobility management entity
NCE network control element
N/W network
OFDM orthogonal frequency division multiplexing
PDSCH physical downlink shared channel
PRB physical resource block
RE resource element
RRH remote radio head
RS reference signal
Rx receiver
SC sub-carrier
SGW serving gateway
sTTI short transmission time interval
TDD time-division duplex
TTI transmission time interval
Tx transmitter
UE user equipment (e.g., a wireless, typically mobile device)

1-47. (canceled)

48. An apparatus, comprising:
at least one processor; and
at least one memory including computer program code, the at least one memory and the computer program code configured to, with the at least one processor, cause the apparatus to perform at least the following:
receive at least one user-specific reference signal in a pattern; and
perform channel estimation based on the at least one user-specific reference signal, wherein at least part of the at least one user-specific reference signal is in a physical resource block allocation of a user equipment and the pattern of the at least one user-specific reference signal includes at least one over-the-edge reference signal received outside of the physical resource block allocation of the user equipment.

49. The apparatus of claim 48, wherein the performing further comprising performing channel estimation based on the pattern of the at least one user-specific reference signal beyond an edge of the physical resource block allocated to the user equipment.

50. The apparatus of claim 48, wherein another physical resource block allocation beyond the edge of the physical resource block allocation of the user equipment is for another user equipment.

51. The apparatus of claim 50, wherein a physical downlink shared channel of said another user equipment is rate matched around the pattern of the at least one user-specific reference signal.

52. The apparatus of claim 48, wherein the pattern of the at least one user-specific reference signal includes at least one in-band reference signal that is within the physical resource block allocation and at least one over-the-edge reference signal that is outside of the physical resource block allocation.

53. The apparatus of claim 52, wherein two or more of the at least one over-the-edge reference signal are uniformly spaced with respect to the at least one in-band reference signal located within the physical resource block allocation.

54. The apparatus of claim 48, wherein the pattern of the at least one user-specific reference signal of the user equipment overlays another pattern of user-specific reference signals of the user equipment.

55. The apparatus of claim 48, wherein a reference signal at an edge of the physical resource block allocation is multiplexed if same resource elements are used for the physical resource block allocation and a physical resource block allocation of a neighboring user equipment.

56. The apparatus of claim 55, wherein the multiplexed reference signal at the edge of the physical resource block allocation results in boosted power of the multiplexed reference signal.

57. The apparatus of claim 48, wherein said at least one over-the-edge reference signal received outside of the physical resource block does not overlap with another physical resource block for another user equipment.

58. A method, comprising:
receiving, by a user equipment, at least one user-specific reference signal in a pattern, and
performing channel estimation based on the at least one user-specific reference signal, wherein at least part of the at least one user-specific reference signal is in a physical resource block allocation of the user equipment and the pattern of the at least one user-specific reference signal includes at least one over-the-edge reference signal received outside of the physical resource block allocation of said user equipment.

59. An apparatus, comprising:
at least one processor; and
at least one memory including computer program code,
the at least one memory and the computer program code configured to, with the at least one processor, cause the apparatus to perform at least the following:
allocate a physical resource block for transmission of at least one user-specific reference signal; and
transmit to a user equipment the at least one user-specific reference signal in a pattern, wherein the pattern of the at least one user-specific reference signal includes at least one over-the-edge reference signal transmitted outside of the physical resource block allocation.

60. The apparatus of claim 59, wherein the pattern of the at least one user-specific reference signal enables channel estimation beyond an edge of the physical resource block allocated to the user equipment.

61. The apparatus of claim 59, wherein another physical resource block beyond the edge of the physical resource block allocation is allocated to another user equipment.

62. The apparatus of claim 59, wherein the pattern of the at least one user-specific reference signal includes at least one in-band reference signal that is within the physical resource block allocation and at least one over-the-edge reference signal that is outside of the physical resource block allocation.

63. The apparatus of claim 62, wherein two or more of the at least one over-the-edge reference signal are uniformly spaced with respect to the at least one in-band reference signal located within the physical resource block allocation.

64. The apparatus of claim 59, wherein a reference signal at an edge of the physical resource block allocation is multiplexed if same resource elements are used for the physical resource block allocation and a physical resource block allocation of a neighboring user equipment.

65. The apparatus of claim 64, wherein the multiplexed reference signal at the edge of the physical resource block allocation results in boosted power of the multiplexed reference signal.

66. The apparatus of claim 59, wherein said at least one over-the-edge reference signal transmitted outside of the physical resource block does not overlap with another physical resource block allocated to another user equipment.

67. The apparatus of claims 59, wherein the pattern of the at least one user-specific reference signal of the user equipment overlays another pattern of user-specific reference signals of the user equipment.
